(19) United States
(12) Patent Application Publication
(10) Pub. No.: US 2003/0090578 A1
(43) Pub. Date: May 15, 2003

(54) Method and apparatus for extending dynamic range between CCD and DSP/ASIC

(75) Inventors: Glenn Waehner, Fresno, CA (US); Jordan R. Christoff, Santa Barbara, CA (US)

Correspondence Address: MARK D MILLER, KIMBLE, MACMICHAEL & UPTON, 5260 NORTH PALM AVENUE, SUITE 221, FRESNO, CA, 93704, US

(73) Assignee: Pelco

(21) Appl. No.: 10/295,594

(22) Filed: Nov. 15, 2002

Related U.S. Application Data
(60) Provisional application No. 60/335,483, filed on Nov. 15, 2001.

(51) Int. Cl. H04N 5/76; H04N 5/225

(52) U.S. Cl. 348/231.1; 386/93

(57) ABSTRACT

The present invention is a circuit for use with a video camera that extends the dynamic range of the camera allowing a limited-range output device to see brighter and darker portions of an image at the same time, and also increasing the low-light sensitivity of the camera, which is of great value in a security application. The circuit of the present invention matches the output dynamic range of a CCD imager to an ADC and subsequent DSP/ASIC by using a logarithmic function to fit a wider input dynamic range onto a narrower output dynamic range.

### BACKGROUND OF THE INVENTION

1. Field of the Invention

The present invention relates to the production of images by a video camera, and more particularly to a circuit that improves the video image produced by a camera by matching the output dynamic range of a CCD (charge coupled device) imager to an ADC (analog to digital converter) and subsequent DSP (digital signal processor) ASIC (application specific integrated circuit) by using a logarithmic function to fit a wider input dynamic range onto a narrower output dynamic range.

2. Description of the Prior Art

In ordinary CCD imager video cameras the output of the CCD is sent to a Correlated Double Sample (CDS) where the actual pixel levels are recovered from a composite signal that also includes clock and timing information. This pre-video signal is then sent to an Analog to Digital Converter (ADC) (or an analog processor in older analog video cameras), where a digital representation of the pixel data is created. This digital signal is a linear representation of the input signal, which means that if 1 volt of pre-video equals 128 digital counts, 2 volts would equal 256 counts. The digital representation is then usually sent to a Digital Signal Processor (often implemented as an Application Specific Integrated Circuit ASIC), where the pre-video is processed to produce a true video output.

Such systems suffer from the drawback that the CCD imager produces an image with greater dynamic range than can be easily processed. This is because most output devices are video monitors or computer screens having a fixed (and somewhat narrow) dynamic range, often much less than the CCD imager. It is also common to experience a loss in quality in a video image that contains both bright and dark information.

It is therefore desirable to provide a circuit for use with a video camera that extends the dynamic range of the camera allowing brighter and darker portions of an image to be sent to a limited-range output device at the same time, and also increasing the low-light sensitivity of the camera, which is of great value in a security application.

### SUMMARY OF THE INVENTION

The present invention provides a circuit for use with a video camera that extends the dynamic range of the camera allowing a limited-range output device attached thereto to see brighter and darker portions of an image at the same time, and also increasing the low-light sensitivity of the camera, which is of great value in a security application. The circuit of the present invention matches the output dynamic range of a CCD imager to an ADC and subsequent DSP/ASIC by using a logarithmic function to fit a wider input dynamic range onto a narrower output dynamic range. In particular, the circuit of the present invention imposes a non-linear transformation between the CDS and the ADC. This non-linearity has the effect of compressing the input information from the CCD into a range that can be fully utilized by the ADC and subsequently by the DSP/ASIC. The non-linearity is a logarithmic function, designed to fit a wider input range into a narrower output range. Specifically the input range is increased by a factor of about 10-20 times, so as to use all the available information from the CCD and fit it into a range usable by the DSP/ASIC.

It is to be appreciated that the methodology could be equally well applied in the digital domain by using a high bit count ADC and then applying the non-linearity using digital methods. The analog processing of the present invention is preferred as a more cost effective and elegant implementation.

By using both black and white level compensation integrators, this circuit is able to automatically insure that the endpoints of the input and output gain curves are matched, while still producing a logarithmic response, thus effectively allowing a wider input dynamic range to be output using standard video output devices which are typically of a narrower dynamic range.

In developing the invention, it was found that it was possible to implement the logarithm using two ADCs and then a Field Programmable Gate Array (FPGA) to digitally create the desired effect. However, while this implementation would work, it was not cost effective.

The present invention was developed by first implementing the logarithm using a single op-amp implementation with a diode as the feedback element. This implementation created the desired non-linearity. However, the start and stop points of the output do not match well with the ADC, so it was not a practical implementation. A gain stage was then added after the logarithmic amplifier to try and match the output to ADC. This improved the circuit, but required extensive adjustment in order to achieve the desired properties. A reference diode was then added to try and compensate for the diode used in the logarithmic amplifier. The reference diode had a known current applied to it, and the resulting voltage (which should be the same as the voltage in the diode used in the logarithmic amplifier) should allow the amplifier to create an output matched to the ADC. The matching of the diodes is critical in this implementation, and such parts are costly, which is a drawback to this implementation.

The preferred embodiment was implemented using automatic compensation circuitry that uses two op-amp integrators to set the black level (the no-signal output level) and the peak level (the maximum signal output level) to known voltages, compensating for part variations, thermal variations and input level variations. The CDS reference voltages are used as the endpoints, thus ensuring the non-linear (logarithmic) amplifier always has the right output levels for minimum (black) and maximum (white).

To set the black level, the input signal is sampled when the pre-video level is known to be at the black level, the integrator then adds an offset signal into the logarithmic amplifier so that the system output is at minimum during this time. To set the peak white level, a switch applies a peak white input to the system during a known time period, an integrator then adds an offset signal into the output amplifier so that the system output is at a maximum during this time. By holding these offset voltages during the horizontal line time (a line of active video) the integrators automatically and continuously (on a line by line basis) insure that the system endpoints (minimum black level and maximum white level) are at exactly the right points for optimum function of the ADC and DSP/ASIC. This circuit results in a greatly extended dynamic range and allows the camera to see brighter and darker portions of an image at the same time. This circuit also has the additional advantage of increasing the low-light sensitivity of the camera, which is of great value in a security application.

It is therefore a primary object of the present invention to provide a circuit for use with a video camera that extends the dynamic range of the camera allowing it to see brighter and darker portions of an image at the same time,

It is also a primary object of the present invention to provide a circuit for use with a video surveillance camera that increases the low-light sensitivity of the camera.

It is also an important object of the present invention to provide an effective, low cost method and apparatus for matching the output dynamic range of a CCD imager to an ADC and subsequent DSP/ASIC by using a logarithmic function to fit a wider input dynamic range onto a narrower output dynamic range.

Additional objects of the invention will be apparent from the detailed descriptions and the claims herein.

### BRIEF DESCRIPTION OF THE DRAWING

FIG. 1 is a schematic of the circuit of the present invention.

### DETAILED DESCRIPTION OF THE PREFERRED EMBODIMENTS

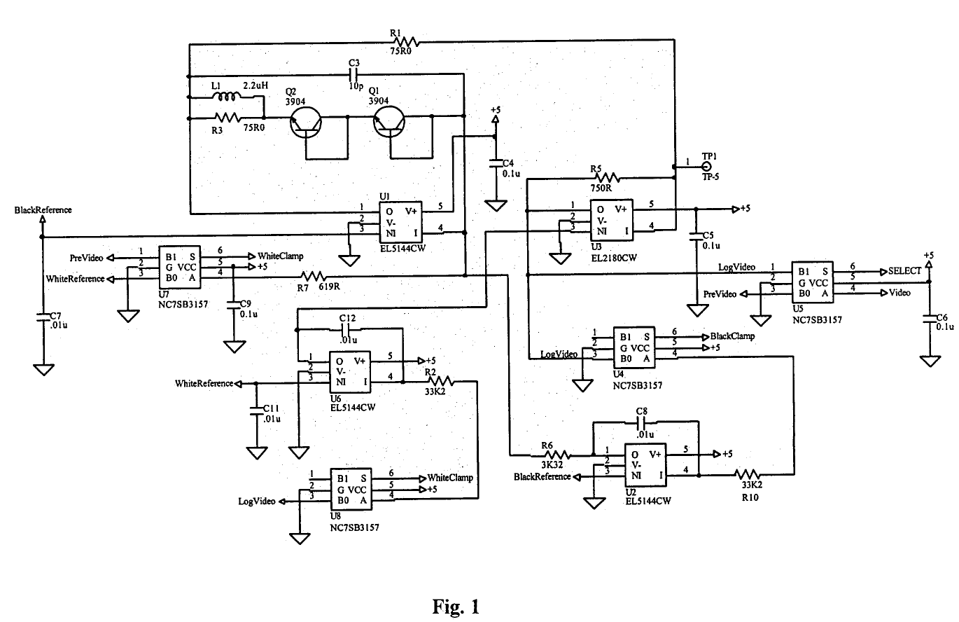

Referring to the schematic of FIG. 1, it is seen that the CCD output pre-video signal is fed into Switch 1 (U7), and normally is passed through to U1 (the logarithmic amplifier) by resistor R7. R7 sets the current into U1 so that the maximum signal level results in a known current.

U1 creates a logarithmic input to output function by using transistors Q1 and Q2 (connected as diodes in series) as feedback elements. It is to be appreciated that Q1 and Q2 could be diodes as well, and that only one is required. However, using two transistors/diodes improves the circuit's gain and helps reduce noise. Capacitor C3 is used to reduce the gain (filter) of unwanted high frequency signals, and thus reduces noise in the system. Inductor L1 and resistor R3 comprise a low-pass filter in the feedback of the logarithmic amplifier circuit so that signals above about 5 MHz (which contain the color information, usually between about 4-5 MHz) are not processed logarithmically (i.e. not compressed the same way), thus preserving their normal color information in the pre-video signal, while still allowing logarithmic response for lower frequency signals (luminance). The signal is then sent to operational amplifier U3 for amplification to match the logarithmic response signal to the proper voltage levels for the ADC. The gain of U3 also sets the degree (amount) of extended dynamic range (i.e. how many decades of logarithmic response the system produces), and is optimized to match the input dynamic range of the CCD to the system's output dynamic range to give the best image of the CCD in use.

Amplifier U5 is the output switch and allows the camera to use either the logarithmic response or the standard response. To invoke or not invoke the circuit, according to user preference. Switch U4 allows the output of the system to be connected to an integrator constructed using amplifier U2 during a period where the pre-video signal is at black level (minimum video level). U2 then creates an offset signal that makes the circuit produce a black level output with black level input. This is important because it compensates for offsets in the logarithmic amplifier U1, the amplifier U3 as well as thermal and other drifts. Without this integrator, extensive manual adjustment on a unit by unit basis and other temperature compensation circuits would be required.

Switch U7 (the input switch) and switch U8 (input to integrator) work in combination to allow an integrator constructed using amplifier U6 to produce an offset signal that makes the circuit produce a white level output with a white level input. Just as in the black level compensation, the white level (maximum video level) must be compensated. During horizontal blanking (a time when the pre-video signal is not used for video output) U7 switches the input to this circuit to a white level. Then, switch U8 connects the output of the circuit to the input of the white level compensating integrator comprised of amplifier U6. U6 then creates an offset that makes the system produce white level output with white level input, this is important because it compensates for offsets in the logarithmic amplifier, the output amplifier as well as thermal and other drifts. Without this integrator U6, extensive manual adjustment and other temperature compensation circuits would be required.

By using both black and white level compensation integrators, this circuit is able to automatically insure that the endpoints of the input and output gain curves are matched, while still producing a logarithmic response, thus effectively allowing a wider input dynamic range to be output using a narrower dynamic range.

In use, the circuit of the present invention first amplifies the desired portion of the wide dynamic range video signal received from an input device. Then, the minimum and maximum output levels from the input device are for automatically and dynamically adjusted to correspond, respectively, to the minimum and maximum dynamic ranges of an output device. Since different input devices may have different dynamic ranges, the circuit allows for adjusting the amount of logarithmic gain applied to the input signal to correspond to the dynamic range available from the input device.

It is to be appreciated that other non-linear gain characteristics could be used instead of the logarithmic ones described herein.

It is to be understood that variations and modifications of the present invention may be made without departing from the scope thereof. It is also to be understood that the present invention is not to be limited by the specific embodiments disclosed herein, but only in accordance with the appended claims when read in light of the foregoing specification.

What is claimed is:

1. A circuit for fitting a wide video input dynamic range onto a more narrow video output dynamic range comprising a means for logarithmically amplifying a video signal received from an input device, a first means for automatically and dynamically adjusting the minimum output level of the video signal to correspond to the minimum range of an output device, and a second means for automatically and dynamically adjusting the maximum output level of the video signal to correspond to the maximum range of said output device.

2. The circuit of claim 1 wherein a means is provided for adjusting the amount of logarithmic gain applied to the input signal to correspond to the dynamic range available from the input device.

3. The circuit of claim 2 wherein a means is provided for selectively applying the logarithmic characteristic to the luminance portion of the signal only.

4. The circuit of claim 3 wherein a first means is provided for automatically compensating a wide black level input to a more narrow black level output, and a second means is provided for automatically compensating a wide white level input to a more narrow white level output level.

5. The circuit of claim 4 wherein the endpoints of a wide video input range are automatically adjusted to match the endpoints of a more narrow video output range.

6. A method for automatically fitting a wide video input dynamic range onto a more narrow output dynamic range comprising the steps of:
a. receiving an input from a video device having a wide dynamic range;
b. logarithmically amplifying said video signal;
c. automatically and dynamically adjusting the minimum output level of the video signal to correspond to the minimum range of an output device; and
d. automatically and dynamically adjusting the maximum output level of the video signal to correspond to the maximum range of said output device.

7. The method of claim 6 including the additional steps of:
e. adjusting the amount of logarithmic gain applied to the input signal to correspond to the dynamic range available from the input device; and
f. selectively applying the logarithmic characteristic to the luminance portion of the signal only.

8. The method of claim 7 including the additional step of:
g. automatically compensating the black level input to a more narrow black level output level; and
h. automatically compensating the wide white level input to a more narrow white level output level.
